(19) United States
(12) Patent Application Publication
(10) Pub. No.: US 2004/0257332 A1
(43) Pub. Date: Dec. 23, 2004

(54) Personal computer and television display system

(76) Inventor: Shlomo Turgeman, Ramar Efal (IL)

Correspondence Address: Dekel Patent Ltd., Beit HaRofim, Room 27, 18 Menuha VeNahala Street, Rehovot, 76209, IL

(21) Appl. No.: 10/600,323

(22) Filed: Jun. 23, 2003

(51) Int. Cl. G09G 5/00

(52) U.S. Cl. 345/156

(57) ABSTRACT

A system including a TV comprising a TV display screen, a PC comprising a PC display screen, a processor in communication with the TV display screen and the PC display screen, the processor being operative to process TV signals for viewing TV images in three display formats, a first display format for displaying the TV images on the TV display screen, a second display format for displaying the TV images in a window on the PC display screen, and a third display format for displaying the TV images on the PC display screen so as to appear similar to the TV images displayed on the TV display screen, and a user switching interface connected to at least one of the PC display screen, the PC, the TV display screen and the TV, for selecting one of the three display formats.

### FIELD OF THE INVENTION

The present invention relates generally to a system for displaying television (TV) images on a personal computer (PC) display screen or TV display screen in different selected formats.

### BACKGROUND OF THE INVENTION

Many systems are known that integrate television (TV) with a personal computer (PC). Some systems permit displaying TV images on a TV screen from a PC equipped with a printed circuit board (PCB) that includes components for receiving TV signals and decoding the signals for display on the screen. Other systems include interface devices, such as but not limited to, a keyboard, a mouse, a joystick or a remote control device, to control either the TV or PC.

For example, U.S. Pat. No. 5,790,201 to Antos describes a television and computer integration system that includes a coupler module electrically coupled to a remote keyboard and integral mouse, and to a PC and TV. The PC has a conventional user interface which includes a keyboard, monitor and mouse. The coupler module enables the combination of the remote keyboard, mouse and TV to serve as a secondary user interface for the PC, which may be operated in parallel with the primary user interface. A user may thus access and take advantage of substantially all of the capabilities of the PC (including computer games and Internet access) from the user's television.

U.S. Pat. No. 6,271,837 to Naiff describes a peripheral device that enables the PC to provide the functions of a set-top box for television reception. The television operations take place in the multitasking environment of the PC, so that the PC can be concurrently used for other applications

U.S. published patent application 2002051083 describes a TV monitor that has a TV mode and a PC mode, and which is connected to a computer via a home network. When a user chooses the TV mode, the TV monitor operates independently of the PC, so that an input/output device of the TV monitor operates as that of the TV monitor. If the user chooses the PC mode, on the other hand, the TV monitor operates as a monitor of the computer, so that the input/output device of the TV monitor operates as that of the computer.

U.S. Pat. No. 6,516,467 to Schindler et al. describes an entertainment system including a PC with a large screen VGA (video graphics adapter) quality monitor. The system has digital satellite broadcast reception, decompression and display capability with multiple radio frequency (RF) remote control devices, which transmit self-identifying signals and have power adjustment capabilities. The remote control devices combine TV and VCR (video cassette recorder) controls with standard PC keyboard controls.

U.S. Pat. No. 6,377,861 to York describes a system with a remote keyboard and a remote pointer to control a PC. The PC generates a PC monitor display and sounds, and the system projects the same display image and plays the sounds on a television. The remote keyboard and remote pointer may be in one room with the television, while the PC is in another room. The PC not only generates and projects its PC monitor display on the TV, but may also control the TV's functions, including program selection, viewing, recording, and scheduling.

### SUMMARY OF THE INVENTION

The present invention seeks to provide an improved system for selectively displaying TV images on a PC display screen or TV display screen in different selected formats, as is described in detail hereinbelow.

There is thus provided in accordance with an embodiment of the present invention a system comprising a TV comprising a TV display screen, a PC comprising a PC display screen, a processor in communication with the TV display screen and the PC display screen, the processor being operative to process TV signals for viewing TV images in three display formats, a first display format for displaying the TV images on the TV display screen, a second display format for displaying the TV images in a window on the PC display screen, and a third display format for displaying the TV images on the PC display screen so as to appear similar to the TV images displayed on the TV display screen, and a user switching interface connected to at least one of the PC display screen, the PC, the TV display screen and the TV, for selecting one of the three display formats.

In accordance with an embodiment of the present invention the user switching interface may comprise a keyboard, a mouse and/or a remote control device.

Further in accordance with an embodiment of the present invention the processor comprises a module embodied on a printed circuit board (PCB).

Still further in accordance with an embodiment of the present invention the module may be installed in the PC, or in a PC monitor associated with the PC display screen.

In accordance with an embodiment of the present invention a first power source may be connected to the module, and a general power source may be operative to power the PC, wherein the first power source is operative to supply power to the module independently from the general power source even when the general power source does not supply power to the PC.

There is also provided in accordance with an embodiment of the present invention a method comprising outputting television (TV) signals in a format suitable for display on a TV screen from a module installed in a personal computer (PC), the module being powered by a first power source independent from a general power source of the PC. The TV signals may then be displayed as a TV picture on a TV screen.

The method may further comprise outputting the TV signals to the TV screen while the PC is turned off.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a system for selectively displaying TV images on a TV display screen and a PC display screen, constructed and operative in accordance with an embodiment of the present invention;

FIG. 2 is a simplified block diagram of circuitry, which may be used to output TV signals to the TV display screen and the PC display screen, in accordance with an embodiment of the present invention;

FIGS. 3-5 are simplified pictorial illustrations of displaying TV images associated with the TV signals in three display formats, wherein in FIG. 3, the TV images may be displayed on the TV display screen, in FIG. 4, the TV images may be displayed in a window on the PC display screen, and in FIG. 5, the TV images may be displayed on the PC display screen so as to appear similar to the TV images displayed on the TV display screen; and

FIG. 6 is a simplified block diagram of circuitry, which may be useful for a module of a processor used in the system of FIG. 1, in accordance with an embodiment of the present invention.

### DETAILED DESCRIPTION OF PREFERRED EMBODIMENTS

Reference is now made to FIG. 1, which illustrates a system 10, constructed and operative in accordance with an embodiment of the present invention.

System 10 may comprise a television (TV) display screen 12 of a TV 13, and a personal computer (PC) monitor 14 comprising a PC display screen 16. TV display screen 12 may comprise any kind of screen technology, For example, TV display screen 12 may be a large screen, such as, but not limited to, from a 19 inch by 40 inch picture tube to a 46 inch by 60 inch projection system, which may be viewed from a distance of one to five meters or more. PC display screen 16 may employ any kind of screen technology. It may have any suitable resolution, such as but not limited to, 640 by 480 pixels.

A processor 18 may be in communication with TV display screen 12 and PC display screen 16. Processor 18 comprises a module that may be embodied on a printed circuit board (PCB) 20 connected to a motherboard (not shown) of a PC 24. Alternatively, PCB 20 may be installed in PC monitor 14. As another alternative, processor 18 may be an independent module connected to any one or all of PC 24, PC monitor 14 and TV 13. PCB 20 may be of any size or shape, such as but not limited to, a PCMCIA (Personal Computer Memory Card International Association) card.

PC 24 is illustrated as a desktop computer, but the invention is not limited to this type of computer, and the invention may be carried out with other kinds of computers, such as but not limited to, a laptop computer.

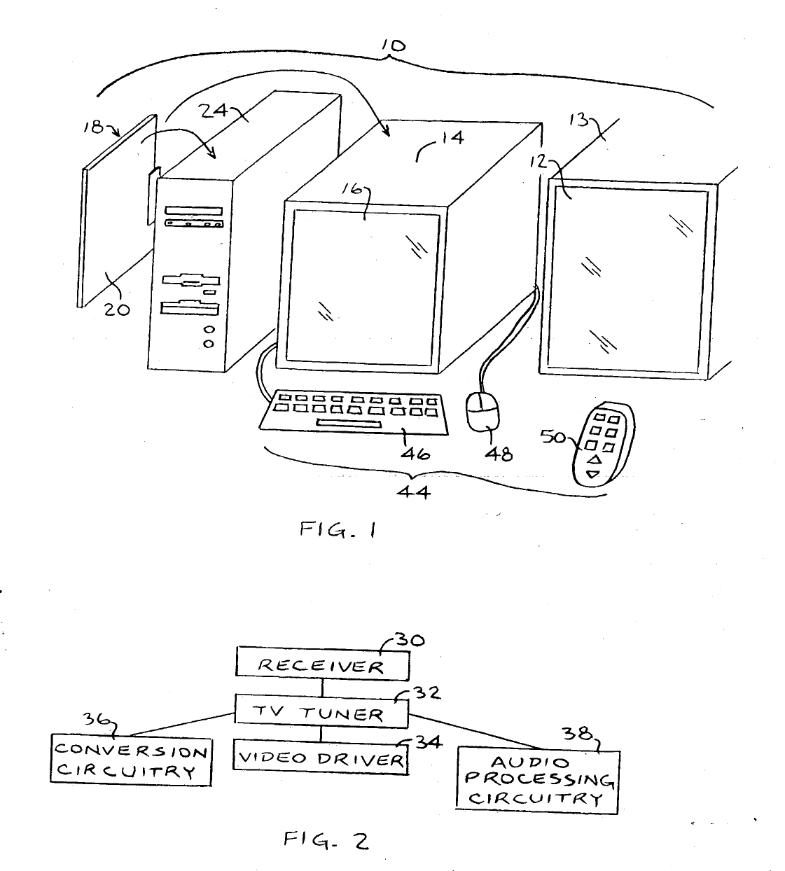

Processor 18 may output TV signals in a format suitable for display on TV display screen 12 or PC display screen 16. Reference is now made to FIG. 2, whic such as by satellite, and may be encoded in accordance with MPEG standards. A TV tuner 32 may be coupled to receiver 30. TV tuner 32 may comprise, for example, a decoder that receives the encoded digital video signal and decodes it into a decoded digital video signal. As another example, the TV broadcast may comprise National Television Systems Committee (NTSC) signals. A video driver 34 may be coupled to TV tuner 32 to convert the decoded video signal into a signal suitable for display on TV display screen 12 and/or PC display screen 16. For example, conversion circuitry 36 may be provided for converting NTSC signals to VGA (video graphics adapter) format, interlaced or not, or vice versa.

Audio processing circuitry 38 may be provided for receiving and processing audio data in the broadcast stream and providing an output suitable for driving speakers (not shown) of TV 13 and PC 24.

Reference is now made to FIGS. 3-5. In accordance with an embodiment of the present invention, processor 18 may process TV signals for viewing TV images in three display formats. In a first display format, seen in FIG. 3, TV images 40 may be displayed on TV display screen 12. TV images 40 may be viewed from a distance of one to five meters or more.

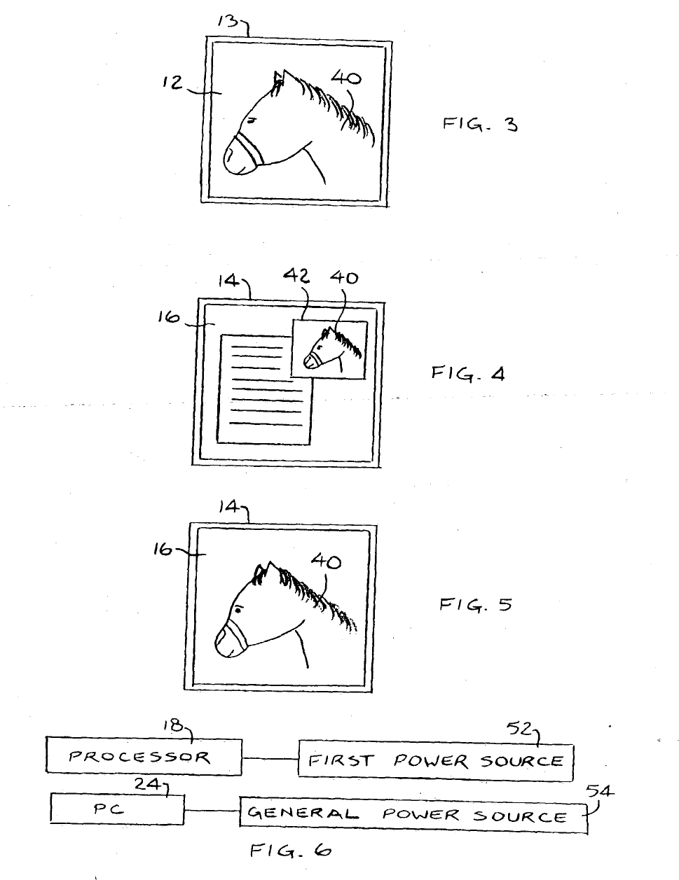

In a second display format, seen in FIG. 4, TV images 40 may be displayed in a window 42 on PC display screen 16. TV images 40 may be viewed from a short-range distance (e.g., 20-100 cm).

In a third display format, seen in FIG. 5, TV images 40 may be displayed on PC display screen 16 so as to appear similar to the TV images displayed on TV display screen 12, wherein TV images 40 may be viewed from a distance of one to five meters or more. TV images 40 may be displayed without cropping.

Reference is made again to FIG. 1. The ability to select and switch between any of the display formats is preferably controlled by processor 18 with suitable software. A user switching interface 44 may be provided for selecting one of the three display formats. User switching interface 44 may be coupled to PC display screen 16 (and/or PC 24) and/or TV display screen 12 (and/or TV 13), by wired or wireless connection (e.g., infrared or BLUETOOTH). User switching interface 44 may comprise, without limitation, a keyboard 46, a mouse 48 or a remote control device 50, for example.

Reference is now made to FIG. 6, which illustrates a simplified block diagram of circuitry, which may be useful for the module of processor 18, in accordance with an embodiment of the present invention.

The module of processor 18 may be powered by a first power source 52, such as but not limited to, a battery. PC 24 may be powered by a general power source 54, such as but not limited to, mains power. In accordance with an embodiment of the present invention, first power source 52 is independent of general power source 54. In other words, first power source 52 may supply power to the module of processor 18 independently from general power source 54. This permits outputting the TV signals from processor 18 to TV display screen 12 or PC display screen 16 (if TV 13 or PC monitor 14 is turned on) even while PC 24 is turned off.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

What is claimed is:

1. A system comprising:
a television (TV) comprising a TV display screen;
a personal computer (PC) comprising a PC display screen;
a processor in communication with said TV display screen and said PC display screen, said processor being operative to process TV signals for viewing TV images in three display formats, a first display format for displaying said TV images on said TV display screen, a second display format for displaying said TV images in a window on said PC display screen, and a third display format for displaying said TV images on said PC display screen so as to appear similar to said TV images displayed on said TV display screen, and
a user switching interface connected to at least one of said PC display screen, said PC, said TV display screen and said TV, for selecting one of said three display formats.

2. The system according to claim 1, wherein said user switching interface comprises a keyboard.

3. The system according to claim 1, wherein said user switching interface comprises a mouse.

4. The system according to claim 1, wherein said user switching interface comprises a remote control device.

5. The system according to claim 1, wherein said processor comprises a module embodied on a printed circuit board (PCB).

6. The system according to claim 5, wherein said module is installed in said PC.

7. The system according to claim 5, wherein said module is installed in a PC monitor associated with said PC display screen.

8. The system according to claim 5, further comprising a first power source connected to said module, and a general power source operative to power said PC, wherein said first power source is operative to supply power to said module independently from said general power source even when said general power source does not supply power to said PC.

9. A system comprising:
a module installed in a PC operative to output TV signals in a format suitable for display on a TV screen;
a first power source connected to said module; and
a general power source operative to power said PC, wherein said first power source is operative to supply power to said module independently from said general power source even when said general power source does not supply power to said PC.

10. The system according to claim 9, wherein said first power source comprises a battery.

11. A method comprising:
outputting television (TV) signals in a format suitable for display on a TV screen from a module installed in a personal computer (PC), said module being powered by a first power source independent from a general power source of said PC.

12. The method according to claim 11, further comprising displaying said TV signals as a TV picture on a TV screen.

13. The method according to claim 11, further comprising outputting said TV signals to said TV screen while said PC is turned off.
